(19) United States
(12) Patent Application Publication
(10) Pub. No.: US 2008/0290790 A1
(43) Pub. Date: Nov. 27, 2008

(54) Organic light emitting display apparatus and method of fabricating the same

(76) Inventor: Dong-Un Jin, Suwon-si (KR)

Correspondence Address: ROBERT E. BUSHNELL, 1522 K STREET NW, SUITE 300, WASHINGTON, DC, 20005-1202, US

(21) Appl. No.: 11/898,244

(22) Filed: Sep. 10, 2007

(30) Foreign Application Priority Data
May 22, 2007 (KR) 10-2007-0049954

(51) Int. Cl. H01J 1/62; H01J 9/00

(52) U.S. Cl. 313/504; 445/24; 257/E33.001

(57) ABSTRACT

An organic light emitting display device and method of making thereof where a black matrix element is not separately formed and where the occurrence of defects caused by separately forming the black matrix element is prevented. The organic light emitting display includes a pixel electrode; and a pixel defining layer having an opening which either entirely exposes the pixel electrode or exposes only a central portion of the pixel electrode, wherein the pixel defining layer has a multi-layered structure at a end surface of the opening of the pixel defining layer.

### CLAIM OF PRIORITY

This application makes reference to, incorporates the same herein, and claims all benefits accruing under 35 U.S.C. §119 from an application for ORGANIC LIGHT EMITTING DISPLAY APPARATUS AND METHOD OF FABRICATING THE SAME earlier filed in the Korean Intellectual Property Office on 22 May 2007 and there duly assigned Serial No. 10-2007-0049954.

### BACKGROUND OF THE INVENTION

1. Field of the Invention

The present invention relates to an organic light emitting display and a method of fabricating the same, and more particularly, to an organic light emitting display having a black matrix element that is not separately formed, thereby preventing the occurrence of defects caused by separately forming the black matrix element, and a method of fabricating the same.

2. Description of the Related Art

An organic light emitting device in an organic light emitting display operates as follows. When an electric signal is provided to a cathode and an anode, holes injected from the anode move to an emission layer and electrons injected from the cathode move to the emission layer. In the emission layer, the holes and electrons are combined to form excitons, and the energy level of the excitons changes from an excited state to a base state, thereby generating light. As a result, an image is displayed. Such organic light emitting display has wide viewing angle, excellent contrast, and quick response speed, and thus is regarded as one of the next-generation of flat panel displays. In general, the organic light emitting display further include a black matrix surrounding respective sub pixels to improve contrast properties.

In a method of fabricating an organic light emitting display, a pixel electrode is formed on a substrate, and the resultant structure is covered by an insulating layer. Then, the insulating layer is patterned to form a pixel defining layer such that a central portion of the pixel electrode is exposed by the pixel defining layer.

In general, a black matrix is disposed on the pixel defining layer. Recently, a method of forming a pixel defining layer together with a black matrix forming material has been disclosed. That is, a black matrix element and a pixel defining layer can be formed in a single body so that an organic light emitting display device has a simple structure and can be easily fabricated. However, in general, the black matrix forming material has high viscosity. Therefore, when the insulating layer is formed using a black matrix forming material and then patterned to form the pixel defining layer having an opening, a black matrix forming material remains on the pixel electrode. When the black matrix forming material remains on the pixel electrode, the black matrix forming material remaining on the pixel electrode absorbs light generated in an emission layer (not shown) formed on the pixel electrode and thus brightness of corresponding pixels decrease. What is needed is a better design and method of making an organic light emitting display where the black matrix layer need not be made separately and where the negative effects of loss of brightness can be avoided.

### SUMMARY OF THE INVENTION

The present invention provides an organic light emitting display having a black matrix element that is not separately formed, thereby preventing defects occurring when the black matrix element is separately formed, and a method of fabricating the same.

According to an aspect of the present invention, there is provided an organic light emitting display including a pixel electrode and a pixel defining layer having an opening which exposes at least a central portion of the pixel electrode, wherein the pixel defining layer has a multi-layered structure at an end surface of the opening of the pixel defining layer. The multi-layered structure can include a black matrix material layer and a layer absent black matrix material, a bottom layer of the multi-layered structure being the layer absent black matrix material. The bottom layer of the multi-layered structure can include one of silicon oxide, silicon nitride, aluminum oxide, indium oxide, thoron oxide and polyimide. The opening of the pixel defining layer can expose only the central portion of the pixel electrode, a bottom layer of the multi-layered structure being a closed structure away from edges of the substrate and having an opening therein, and external ends of the bottom layer of the multi-layered structure correspond to external ends of the pixel electrode. The opening of the pixel defining layer can expose only the central portion of the pixel electrode, and a bottom layer of the multi-layered structure covers external ends of the pixel electrode. Ends of the opening of the pixel defining layer can expose an entirely of the pixel electrode, and wherein in the end surface of the pixel defining layer, the thickness of the bottom layer of the multi-layered structure is greater than the thickness of the pixel electrode.

According to another aspect of the present invention, there is provided an method of fabricating an organic light emitting display, the method including forming a conductive layer on a substrate, forming a first insulating layer on the conductive layer, forming a pixel electrode and a sacrificial layer which covers the pixel electrode and has ends corresponding to ends of the pixel electrode respectively by patterning the conductive layer and the first insulating layer into an closed pattern away from edges of the substrate, forming a second insulating layer covering the pixel electrode and the sacrificial layer, exposing only a central portion of the sacrificial layer by forming an opening in the second insulating layer and exposing a central portion of the pixel electrode by removing the portion of the sacrificial layer exposed by the opening of the second insulating layer. The second insulating layer is comprised of a black matrix forming material. The first insulating layer being one of silicon oxide, silicon nitride, aluminum oxide, indium oxide, thoron oxide and polyimide.

According to another aspect of the present invention, there is provided a method of fabricating an organic light emitting display, the method including forming a pixel electrode on a substrate, forming a first insulating layer covering the pixel electrode, forming a second insulating layer covering the first insulating layer, exposing a portion of the first insulating layer corresponding to the pixel electrode by forming an opening in the second insulating layer and exposing the pixel electrode by removing the portion of the first insulating layer exposed by the opening of the second insulating layer. The opening formed in the second insulating layer can expose only a portion of the first insulating layer corresponding to only a central portion of the pixel electrode, and in the exposing the pixel electrode, only the central portion of the pixel electrode can be exposed. The second insulating layer can include a black matrix forming material. The first insulating layer can be one of silicon oxide, silicon nitride, aluminum oxide, indium oxide, thoron oxide and polyimide.

According to anther aspect of the present invention, there is provided a method of fabricating an organic light emitting display, the method including forming a conductive layer on a substrate, forming a first insulating layer on the conductive layer, forming a pixel electrode and a sacrificial layer which covers the pixel electrode and has ends corresponding to ends of the pixel electrode respectively by pattering the conductive layer and the first insulating layer into a closed pattern away from edges of the substrate, forming a second insulating layer covering the pixel electrode and the sacrificial layer, exposing the sacrificial layer by forming an opening in the second insulating layer and exposing the pixel electrode by removing the sacrificial layer. The second insulating layer can include a black matrix forming material. The first insulating layer can include one of silicon oxide, silicon nitride, aluminum oxide, indium oxide, thoron oxide and polyimide.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIGS. 1A and 1B are schematic, sectional views partially illustrating a method of fabricating an organic light emitting display;

FIGS. 2A through 2F are schematic, sectional views illustrating a method of fabricating an organic light emitting display according to an embodiment of the present invention;

FIGS. 3A through 3D are schematic, sectional views illustrating a method of fabricating an organic light emitting display according to another embodiment of the present invention;

FIGS. 4A through 4D are schematic, sectional views illustrating a method of fabricating an organic light emitting display according to another embodiment of the present invention; and

FIGS. 5A through 5F are schematic, sectional views illustrating a method of fabricating an organic light emitting display according to another embodiment of the present invention.

### DETAILED DESCRIPTION OF THE INVENTION

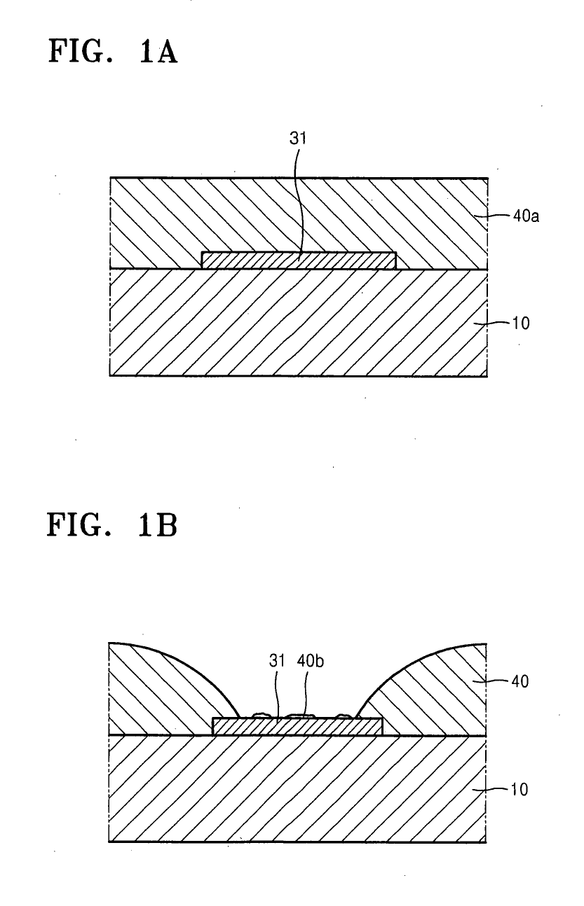

FIGS. 1A and 1B are schematic, sectional views partially illustrating a method of fabricating an organic light emitting display. Referring to FIG. 1A, a pixel electrode 31 is formed on a substrate 10, and the resultant structure is covered by an insulating layer 40a. Then, the insulating layer 40a is patterned to form a pixel defining layer 40 as illustrated in FIG. 1B such that a central portion of the pixel electrode 31 is exposed by the pixel defining layer 40.

In general, a black matrix is disposed on the pixel defining layer 40. Recently, a method of forming a pixel defining layer 40 using together with a black matrix forming material has been disclosed. That is, a black matrix element and a pixel defining layer can be formed in a single body so that an organic light emitting display device has a simple structure and can be easily fabricated. However, in general, the black matrix forming material has high viscosity. Therefore, when the insulating layer 40a is formed using a black matrix forming material as illustrated in FIG. 1A and then patterned to form the pixel defining layer 40 having an opening as illustrated in FIG. 1B, a black matrix forming material 40b remains on the pixel electrode 31. When the black matrix forming material 40b remains on the pixel electrode 31, the black matrix forming material 40b remaining on the pixel electrode 31 absorbs light generated in an emission layer (not shown) formed on the pixel electrode 31 and thus brightness of corresponding pixels decrease.

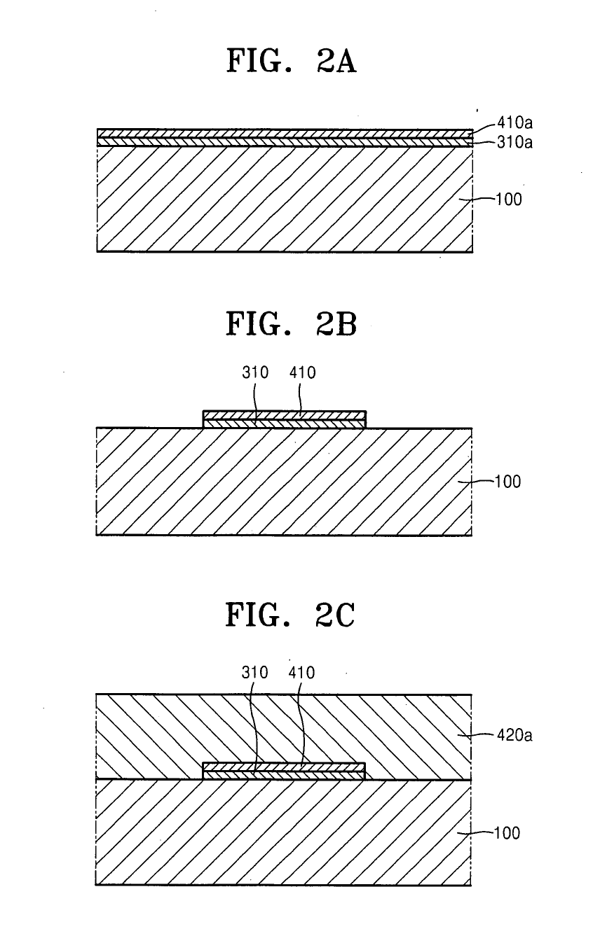

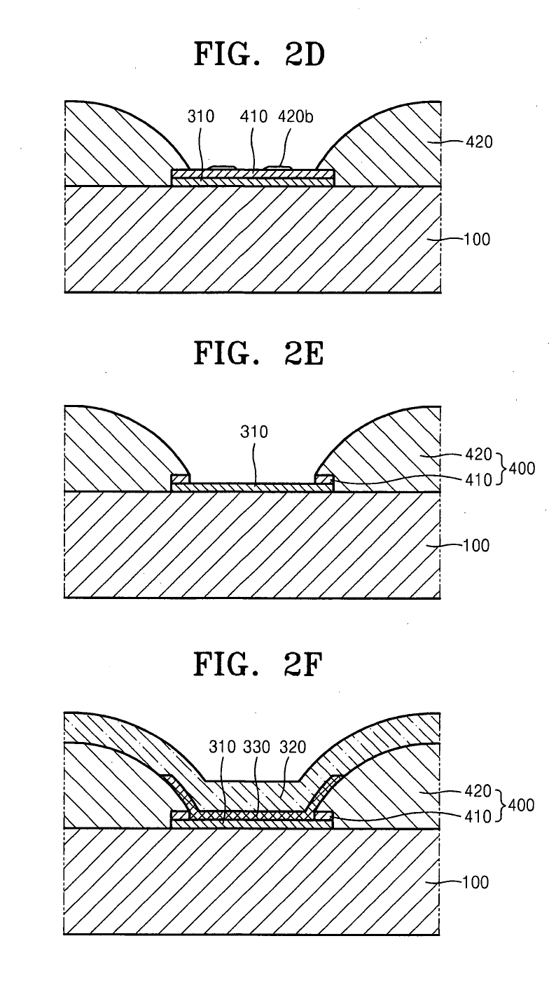

FIGS. 2A through 2F are schematic, sectional views illustrating a method of fabricating an organic light emitting display according to an embodiment of the present invention. In the present embodiment, the organic light emitting display can be an active-matrix organic light emitting display, in which respective pixels include a thin film transistor, however, the organic light emitting display can also be a passive-type organic light emitting display. The descriptions regarding the method of fabricating an organic light emitting display according to the current embodiment can be also valid for other methods according to other embodiments of the present invention, which will be described later.

Referring to FIG. 2A, a conductive layer 310a is formed on a substrate 100. The conductive layer 310a will be patterned later to form a pixel electrode. The substrate 100 can be a glass-based substrate, a plastic-based substrate such as an acryl substrate, or a metal substrate. However, the substrate 100 of the organic light emitting display according to the current embodiment is not limited thereto. Meanwhile, before the conductive layer 310a is formed on the substrate 100, a thin film transistor array can be formed on the substrate 100.

The conductive layer 310a can be formed on the substrate 100 using a deposition method or a sputtering method. The conductive layer 310a formed on the substrate 100 can be a transparent conducting layer or a reflective conducting layer. When the conductive layer 310a is a transparent conducting layer, the conductive layer 310a can be made out of ITO (indium tin oxide), IZO (indium zinc oxide), ZnO, or In₂O₃; whereas when the conductive layer 310a is a reflective conducting layer, the conductive layer 310a can be formed by forming a reflective layer made of Ag, Mg, Al, Pt, Pd, Au, Ni, Nd, Ir, Cr, or a blend thereof, and then forming a layer of ITO, IZO, ZnO, or In₂O₃ on the reflective layer.

After the conductive layer 310a is formed on the substrate 100, a first insulating layer 410a is formed on the conductive layer 310a. The first insulating layer 410a can be formed using various methods, such as a deposition method or a sputtering method. The first insulating layer 410a can be made out of silicon oxide, silicon nitride, aluminum oxide, indium oxide, thoron oxide, or polyimide, but can also be made out of other materials. For example, the first insulating layer 410a can be made out of any insulating material that can be completely removed and thus does not remain on the conductive layer 310a when the first insulating layer 410a is partly or entirely removed, which will be described later.

After the conductive layer 310a and the first insulating layer 410a are formed on the substrate 100 as described above, the conductive layer 310a and the first insulating layer 410a are patterned into an island shape (i.e., a closed pattern away from edges of the substrate) to respectively form a pixel electrode 310 and a sacrificial layer 410 covering the pixel electrode 310, wherein ends of the sacrificial layer 410 correspond to ends of the pixel electrode 310 (i.e., they are coincident), as illustrated in FIG. 2B. That is, the conductive layer 310a is patterned to form the pixel electrode 310, and the first insulating layer 410a is patterned to form the sacrificial layer 410. The conductive layer 310a and the first insulating layer 410a can be patterned using various methods, such as a photography method using a photoresist or a laser ablation method in which a laser beam is irradiated to portions of the conductive layer 310a and the first insulating layer 410a, which are to be removed.

After the pixel electrode 310 and sacrificial layer 410 are formed, a second insulating layer 420a covering the pixel electrode 310 and the sacrificial layer 410 is formed as illustrated in FIG. 2C. The second insulating layer 420a can be formed using various methods. For example, the second insulating layer 420a can be formed using a photoresist including a black additive. The black additive can be, for example, chrome or chromeoxide. The material for forming the second insulating layer 420a is not limited to the above material, and can be any black matrix forming insulating material.

After the second insulating layer 420a is formed, a central portion of the sacrificial layer 410 is exposed by forming an opening in the second insulating layer 420a. Thus, as illustrated in FIG. 2D, a black matrix layer 420 having the opening is formed. When the second insulating layer 420a is formed using the photoresist including a black additive, a photolithography method can be used to form the opening in the second insulating layer 420a to form the black matrix layer 420.

In general, the black matrix forming material as described above has high viscosity. Accordingly, as illustrated in FIG. 2D, when the black matrix layer 420 is formed by forming an opening in the second insulating layer 420a that includes a black matrix forming material, the black matrix forming material 420b can remain on the sacrificial layer 410. According to the method of fabricating an organic light emitting display according to the current embodiment, after the black matrix layer 420 is formed, as illustrated in FIG. 2E, a portion of the sacrificial layer 410 exposed by the black matrix layer 420, that is, a second insulating layer, is removed to expose a central portion of the pixel electrode 310. At this time, the black matrix forming material 420b remaining on the sacrificial layer 410 can be removed together with the sacrificial layer 410. The portion of the sacrificial layer 410 exposed by the black matrix layer 420, that is, a second insulating layer, can be removed using, for example, an ablation method in which a predetermined region is removed by laser beam irradiation. The portion of the sacrificial layer 410 exposed by the black matrix layer 420, that is, a second insulating layer, can be removed using a conventional etching method, such as a wet etching method or a dry etching method. For example, when the sacrificial layer 410 is made out of silicon oxide or the like and the pixel electrode 310 made of ITO or the like, a buffered oxide etchant (BOE) can be used to selectively etch the sacrificial layer 410 made of silicon oxide or the like while the pixel electrode 310 made of ITO or the like is not etched. When the sacrificial layer 410 is made out of polyimide and the pixel electrode 310 is made out of ITO or the like, a developing solution or stripper can be used to selectively etch the sacrificial layer 410 made out of polyimide while the pixel electrode 310 made out of ITO or the like is not etched. At this time, the developing solution selectively etching the sacrificial layer 410 can be any developing solution used in a conventional photolithography method that does not etch the black matrix layer 420 including the black matrix forming material. The sacrificial layer 410 having an opening in its central portion and the black matrix layer 420 constitute a pixel defining layer 400.

Then, as illustrated in FIG. 2F, an intermediate layer 330 and a facing electrode 320 are formed. The intermediate layer 330 includes at least an emission layer. The intermediate layer 330 can be made out of a low molecular weight material or a high molecular weight material. When the intermediate layer 330 is made out of a low molecular weight material, the intermediate layer 330 can be formed by stacking a hole injection layer (HIL), a hole transport layer (HTL), an organic emission layer (EML), an electron transport layer (ETL), an electron injection layer (EIL), and a hole blocking layer (HBL), each of which can be a single layer or a composite layer. An available low molecular weight material can be copper phthalocyanine (CuPc), N,N′-Di naphthalene-1-yl-N,N′-diphenyl-benzidine (NPB), tris-8-hydroxyquinoline aluminum (Alq3), or the like. The intermediate layer 330 can be formed using a deposition method. When the intermediate layer 330 is made out of a high molecular weight organic material, the intermediate layer 330 can include a hole transport layer (HTL) and an emission layer (EML). At this time, the HTL can be made out of PEDOT, and the EML can be made out of a high molecular weight organic material, such as poly-phenylenevinylene (PPV)-based material and a polyfluorene-based material. At this time, the intermediate layer 330 can be formed using a deposition method or a thermal transferring method. The material used to form the intermediate layer 330 in the current embodiment is not limited to the above material, and can be any material that is suitable for forming the intermediate layer 330 of an organic light emitting device.

After the intermediate layer 330 is formed, the facing electrode 320 is formed. The facing electrode 320 can be a transparent electrode or a reflective electrode. When the facing electrode 320 is a transparent electrode, the facing electrode 320 can be formed by depositing a layer made out of Li, Ca, LiF/Ca, LiF/Al, Al, Mg, or a compound thereof on the intermediate layer 330, and then forming an assistant electrode or a bus electrode line made out of a transparent conductive material, such as ITO, IZO, ZnO, or In₂O₃, on the layer. When the facing electrode 320 is a reflective electrode, the facing electrode 320 can be made by depositing Li, Ca, LiF/Ca, LiF/Al, Al, Mg, or a compound thereof.

An organic light emitting display as illustrated in FIG. 2F can be fabricated through these processes described above. The organic light emitting display will now be described in detail. The organic light emitting display includes a pixel electrode 310, a facing electrode 320, an intermediate layer 330 including at least an emission layer interposed between the pixel electrode 310 and the facing electrode 320, and a pixel defining layer 400 having an opening exposing a central portion of the pixel electrode 310. At this time, the pixel defining layer 400 has a multi-layered structure at the end surface of the opening of the pixel defining layer 400. For example, the pixel defining layer 400 includes a black matrix material layer 420, which is not the bottom layer 410 in the multi-layered structure. In the multi-layered structure, the bottom layer 410 can be a layer of silicon oxide, silicon nitride, aluminum oxide, indium oxide, thoron oxide, or polyimide. The bottom layer 410 in the layered structure of the pixel defining layer 400 can have the shape of an island having an opening. External ends of the bottom layer 410 can correspond to external ends of the pixel electrode 310. The structure of the end surface of the opening of the pixel defining layer 400 is not limited to the two-layered structure illustrated in FIG. 2F, and can include more than two layers.

In the case of the organic light emitting display fabricated as described above, a black matrix element is not separately formed but is formed as a single body with a pixel defining layer. Therefore, the organic light emitting display has a simple structure, and thus can be easily fabricated at low costs. Unlike an organic light emitting display of FIGS. 1A and 1B, the organic light emitting display fabricated as described above does not have black matrix forming material remaining on the pixel electrode 310, and thus defects rates can be significantly decreased in the fabricating processes.

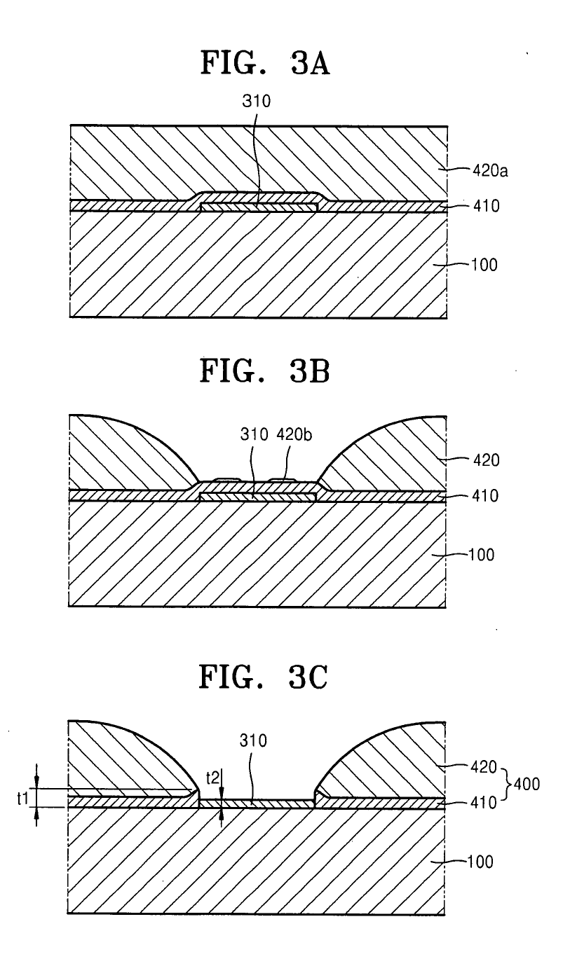

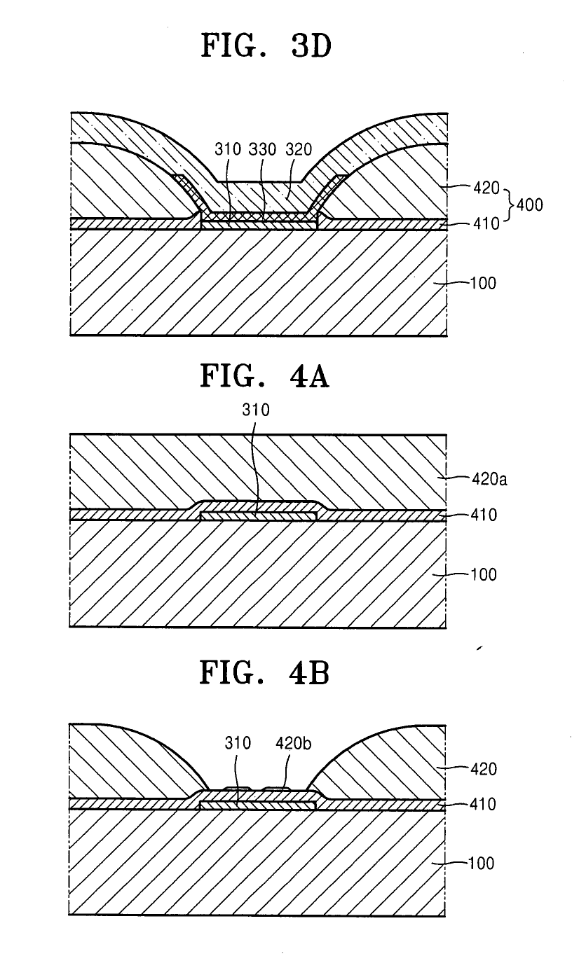

FIGS. 3A through 3D are schematic, sectional views illustrating a method of fabricating an organic light emitting display according to another embodiment of the present invention. Referring to FIG. 3A, a pixel electrode 310 is formed on a substrate 100, the pixel electrode 310 is covered by a first insulating layer 410, and the first insulating layer 410 is covered by a second insulating layer 420a. The pixel electrode 310 can be formed on the substrate 100 using various methods, such as a deposition method or a sputtering method. The pixel electrode 310 can be made by forming a conductive layer on the entire surface of the substrate 100 and then pattering the resultant structure. Alternatively, the pixel electrode 310 can be formed by deposition using a mask.

The first insulating layer 410 will be a sacrificial layer later, and can be formed using various methods, such as a deposition method or a sputtering method. An available material used to form the first insulating layer 410 can be silicon oxide, silicon nitride, aluminum oxide, indium oxide, thoron oxide, or polyimide, but is not limited thereto. For example, the available material used to form the first insulating layer 410 can be any insulating material that can be completely removed from the pixel electrode 310.

A second insulating layer 420a covers the first insulating layer 410, that is the sacrificial layer. The second insulating layer 420a can be formed using various methods. For example the second insulating layer 420a can be formed using a photoresist including a black additive. The black additive can be chrome or chromeoxide. The second insulating layer 420a can be formed using other materials. For example, the second insulating layer 420a can be formed using any insulating black matrix forming material.

After the second insulating layer 420a is formed, an opening is formed in the second insulating layer 420a such that a portion of the first insulating layer 410, that is, a portion of the sacrificial layer corresponding to the pixel electrode 310, is exposed. As a result, a black matrix layer 420 having an opening is formed as illustrated in FIG. 3B. When the second insulating layer 420a is formed using photoresist including a black additive, a conventional photolithography method can be used to form the opening in the second insulating layer 420a to form the black matrix layer 420.

A black matrix forming material has high viscosity. Hence, when the black matrix layer 420 is formed by forming the opening in the second insulating layer 420a made out of a black matrix forming material as illustrated in FIG. 3B, the black matrix forming material 420b can remain on the sacrificial layer 410. According to the current embodiment, after the black matrix layer 420 is formed, as illustrated in FIG. 3C, a portion of the sacrificial layer 410, that is, a first insulating layer exposed by the black matrix layer 420, is removed. In other words, a portion of the sacrificial layer 410 exposed by the opening of the second insulating layer 420a is removed to expose the pixel electrode 310. At this time, a black matrix forming material 420b remaining on the sacrificial layer 410 is also removed. The portion of the sacrificial layer 410 exposed by the black matrix layer 420 can be removed using various methods, such as a laser ablation method, a wet etching method, or a dry etching method. The sacrificial layer 410 having an opening exposing the pixel electrode 310 and the black matrix layer 420 constitute a pixel defining layer 400. Then, as illustrated in FIG. 3D, an intermediate layer 330 and a facing electrode 320 are formed. An organic light emitting display illustrated in FIG. 3D can be fabricated through these processes as described above.

The organic light emitting display fabricated as described above includes a pixel electrode 310, a facing electrode 320, an intermediate layer 330 including at least an emission layer interposed between the pixel electrode 310 and the facing electrode 320, and a pixel defining layer 400 having an opening entirely exposing the pixel electrode 310. At this time, the pixel defining layer 400 has a multi-layered structure at the end surface of the opening of the pixel defining layer 400. The multi-layered structure includes a black matrix material layer 420. The black matrix material layer 420 is not the bottom layer in the multi-layered structure. A bottom layer 410 can include silicon oxide, silicon nitride, aluminum oxide, indium oxide, thoron oxide, or polyimide. Ends of the opening of the pixel defining layer 400 correspond to external ends of the pixel electrode 310, so that the opening of the pixel defining layer 400 entirely exposes the pixel electrode 310. The pixel defining layer 400 has a multi-layered structure at the end surface of its opening. At this time, the thickness t1 of the bottom layer 410, that is, a sacrificial layer, of the multi-layered structure of the surface of the end portion of the opening of the pixel defining layer 400 can be greater than the thickness t2 of the pixel electrode 310.

In the case of the organic light emitting display fabricated as described above, a black matrix element is not separately formed but is formed in the same body with a pixel defining layer. Therefore, the organic light emitting display has a simple structure, and thus can be easily fabricated at low costs. Unlike an organic light emitting display of FIGS. 1A and 1B, the organic light emitting display fabricated as described above does not include a black matrix forming material remaining on the pixel electrode 310, and thus defects rates can be significantly decreased in the fabricating processes.

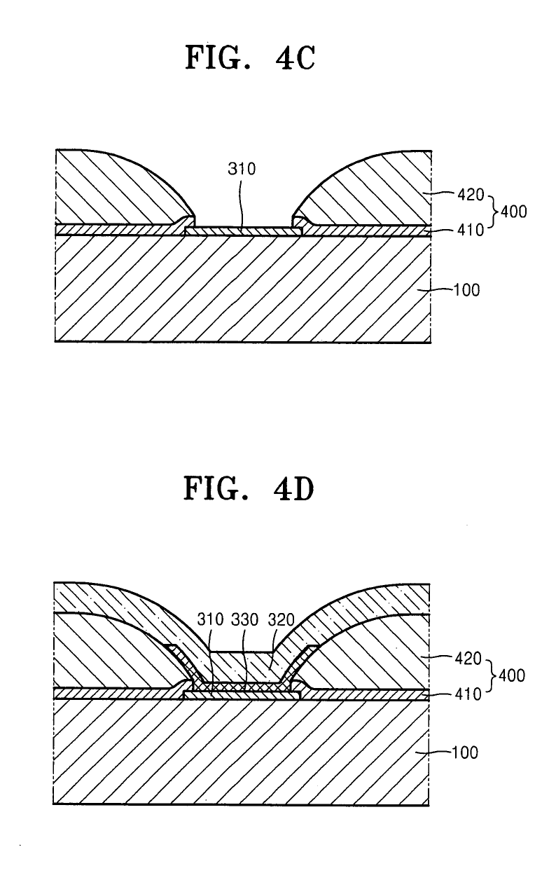

FIGS. 4A through 4D are schematic, sectional views illustrating a method of fabricating an organic light emitting display according to another embodiment of the present invention. Like the fabricating process described with reference to FIG. 3A, a pixel electrode 310 is formed on a substrate 100, the pixel electrode 310 is covered by a first insulating layer 410 which is a sacrificial layer, and the first insulating layer 410 is covered by a second insulating layer 420a (see FIG. 4A). The first insulating layer 410 can be made out of silicon oxide, silicon nitride, aluminum oxide, indium oxide, thoron oxide, or polyimide. The second insulating layer 420a can be made out of a black matrix forming material, such as a photoresist including a black additive.

Then, an opening is formed in the second insulating layer 420a to expose a portion of the first insulating layer 410 which is the sacrificial layer. Specifically, the opening is formed in second insulating layer 420a such that a portion of the first insulating layer 410 corresponding to a central portion of the pixel electrode 310 is exposed. Therefore, as illustrated in FIG. 4B, a black matrix layer 420 having the opening is formed. When the second insulating layer 420a is formed using a photoresist including a black additive, the black matrix layer 420 can be made during the opening in the second insulating layer 420a using a conventional photolithography method.

In general, the black matrix forming material has high viscosity. Hence, when the opening is formed in the second insulating layer 420a that includes a black matrix forming material to form the black matrix layer 420 as illustrated in FIG. 4B, the black matrix forming material 420b can remain on the sacrificial layer 410. According the method of fabricating an organic light emitting display fabricated according to the current embodiment, after the black matrix layer 420 is formed, as illustrated in FIG. 4C, a portion of the sacrificial layer 410, that is, a first insulating layer exposed by the black matrix layer 420, is removed. In other words, a portion of the sacrificial layer 410 exposed by the opening of the black material layer 420 is removed to expose a central portion of the pixel electrode 310. At this time, a black matrix forming material 420b remaining on the sacrificial layer 410 is also removed. The portion of the sacrificial layer 410 exposed by the black matrix layer 420 can be removed using various methods, such as a laser ablation method, a wet etching method, or a dry etching method. The sacrificial layer 410 having the opening exposing the pixel electrode 310 and the black matrix layer 420 together constitute a pixel defining layer 400. Then, as illustrated in FIG. 4D, an intermediate layer 330 and a facing electrode 320 are formed. An organic light emitting display illustrated in FIG. 4D can be fabricated through these processes as described above.

The organic light emitting display fabricated as described above includes a pixel electrode 310, a facing electrode 320, an intermediate layer 330 including at least an emission layer interposed between the pixel electrode 310 and the facing electrode 320, and a pixel defining layer 400 having an opening exposing a central portion of the pixel electrode 310. At this time, the pixel defining layer 400 has a multi-layered structure at the end surface of the opening of the pixel defining layer 400. The multi-layered structure includes a black matrix material layer 420. The black matrix material layer 420 is not the bottom layer in the multi-layered structure. A bottom layer 410 can include silicon oxide, silicon nitride, aluminum oxide, indium oxide, thoron oxide, or polyimide. At this time, the central portion of the pixel electrode 310 is exposed by the opening of the pixel defining layer 400, and external ends of the pixel electrode 310 are covered by portions of the bottom layer 410 of the multi-layered structure of the pixel defining layer 400 exposed by the opening of the pixel defining layer 400.

In the case of the organic light emitting display fabricated as described above, a black matrix element is not separately formed but is instead formed in the same body with a pixel defining layer. Therefore, the organic light emitting display has the simple structure, and thus can be easily fabricated at low costs. Unlike an organic light emitting display, the organic light emitting display fabricated as described above does not include a black matrix forming material remaining on the pixel electrode 310, and thus defects rates can be significantly decreased in fabricating processes.

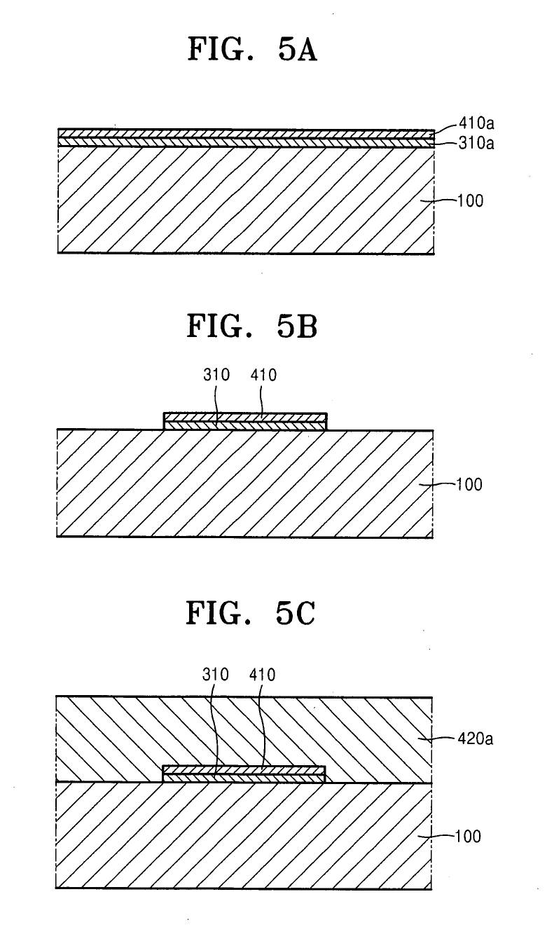

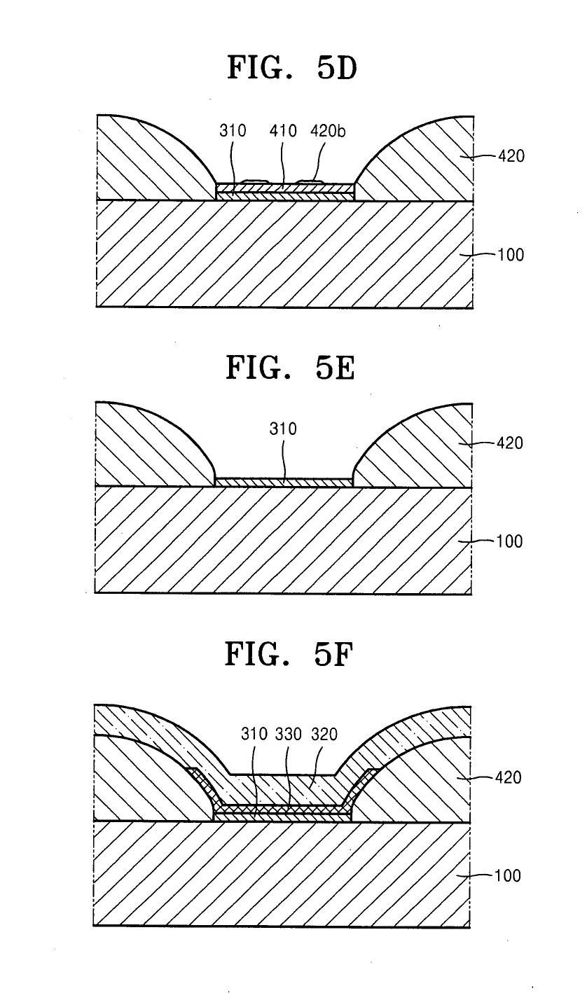

FIGS. 5A through 5F are schematic, sectional views illustrating a method of fabricating an organic light emitting display according to another embodiment of the present invention. The method of fabricating an organic light emitting display according to the current embodiment is similar to the method of fabricating an organic light emitting display described with reference to FIGS. 2A through 2F. As illustrated in FIG. 5A, a conductive layer 310a is formed on a substrate 100, and a first insulating layer 410a is formed on the conductive layer 310a. Then, as illustrated in FIG. 5B, the conductive layer 310a and the first insulating layer 410a are patterned to have an island shape (i.e., a closed pattern located away from any edge of the substrate) to form a pixel electrode 310, and a sacrificial layer 410 covering the pixel electrode 310 and having ends corresponding to ends (i.e., coincident) of the pixel electrode 310, respectively. That is, the conductive layer 310a is patterned to form the pixel electrode 310, and the first insulating layer 410a is patterned to form the sacrificial layer 410. Then, as illustrated in FIG. 5C, a second insulating layer 420a covering the pixel electrode 310 and the sacrificial layer 410 is formed using a black matrix forming material.

After the second insulating layer 420a is formed, as illustrated in FIG. 5D, an opening is formed in the second insulating layer 420a to expose the sacrificial layer 410 to form an opening in the black matrix layer 420. When the second insulating layer 420a is formed using a photoresist including a black additive, a conventional photolithography method can be used to form the opening in the second insulating layer 420a to form the black matrix layer 420.

In general, the black matrix forming material has high viscosity. Hence, when the black matrix layer 420 is formed by forming the opening in the second insulating layer 420a made out of a black matrix forming material, as illustrated in FIG. 5D, the black matrix forming material 420b can remain on the sacrificial layer 410. According the method of fabricating an organic light emitting display fabricated according to the current embodiment, after the black matrix layer 420 is formed, as illustrated in FIG. 5E, the sacrificial layer 410 is removed to expose the pixel electrode 310. At this time, the black matrix forming material 420b remaining on the sacrificial layer 410 is also removed. The sacrificial layer 410 can be removed using various methods, such as a laser ablation method, a wet etching method, or a dry etching method. In the case of an organic light emitting display fabricated using the method according to the current embodiment, the black matrix layer 420 can act as a pixel defining layer. Then, as illustrated in FIG. 5F, an intermediate layer 330 and a facing electrode 320 are formed. An organic light emitting display illustrated in FIG. 5F can be fabricated using the method described.

The organic light emitting display fabricated using the method described above includes a pixel electrode 310, a facing electrode 320, an intermediate layer 330 including at least one emission layer interposed between the pixel electrode 310 and the facing electrode 320, and a pixel defining layer 420 having an opening exposing the pixel electrode 310. At this time, the pixel defining layer 420 can be a single layer as illustrated in FIG. 5F. However, when required, the pixel defining layer 420 can have a multi-layered structure. When the pixel defining layer 420 is a single layer as illustrated in FIG. 5F, the pixel defining layer 420 can include a black matrix forming material.

In the case of the organic light emitting display fabricated as described above, a black matrix element is not separately formed, but is formed in the same body with a pixel defining layer. Therefore, the organic light emitting display has a simple structure, and thus can be easily fabricated at low costs. Unlike an organic light emitting display of FIGS. 1A and 1B, the organic light emitting display fabricated as described above does not include a black matrix forming material remaining on the pixel electrode 310, and thus defects rates can be significantly decreased in the fabricating processes of the present invention. In the case of an organic light emitting display and a method of fabricating an organic light emitting display according to the present invention, a black matrix element is not separately formed, and defects caused by separately forming the black matrix element can be prevented.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. An organic light emitting display, comprising:
a pixel electrode; and
a pixel defining layer having an opening which exposes at least a central portion of the pixel electrode, wherein the pixel defining layer has a multi-layered structure at an end surface of the opening of the pixel defining layer.

2. The organic light emitting display of claim 1, wherein the multi-layered structure comprises a black matrix material layer and a layer absent black matrix material, a bottom layer of the multi-layered structure being the layer absent black matrix material.

3. The organic light emitting display of claim 1, wherein the bottom layer of the multi-layered structure comprises an element selected from a group consisting of silicon oxide, silicon nitride, aluminum oxide, indium oxide, thoron oxide and polyimide.

4. The organic light emitting display of claim 1, wherein the opening of the pixel defining layer exposes only the central portion of the pixel electrode, a bottom layer of the multi-layered structure being a closed structure away from edges of a substrate and having an opening therein, and external ends of the bottom layer of the multi-layered structure correspond to external ends of the pixel electrode.

5. The organic light emitting display of claim 1, wherein the opening of the pixel defining layer exposes only the central portion of the pixel electrode, and a bottom layer of the multi-layered structure covers external ends of the pixel electrode.

6. The organic light emitting display of claim 1, wherein ends of the opening of the pixel defining layer exposes an entirety of the pixel electrode, and wherein in the end surface of the pixel defining layer, the thickness of the bottom layer of the multi-layered structure is greater than the thickness of the pixel electrode.

7. A method of fabricating an organic light emitting display, comprising:
forming a conductive layer on a substrate;
forming a first insulating layer on the conductive layer;
forming a pixel electrode and a sacrificial layer which covers the pixel electrode and has ends corresponding to ends of the pixel electrode respectively by patterning the conductive layer and the first insulating layer into an closed pattern away from edges of the substrate;
forming a second insulating layer covering the pixel electrode and the sacrificial layer;
exposing only a central portion of the sacrificial layer by forming an opening in the second insulating layer; and
exposing a central portion of the pixel electrode by removing the portion of the sacrificial layer exposed by the opening of the second insulating layer.

8. The method of claim 7, wherein the second insulating layer is comprised of a black matrix forming material.

9. The method of claim 7, wherein the first insulating layer is comprised of an element selected from the group consisting of silicon oxide, silicon nitride, aluminum oxide, indium oxide, thoron oxide and polyimide.

10. A method of fabricating an organic light emitting display, comprising:
forming a pixel electrode on a substrate;
forming a first insulating layer covering the pixel electrode;
forming a second insulating layer covering the first insulating layer;
exposing a portion of the first insulating layer corresponding to the pixel electrode by forming an opening in the second insulating layer; and
exposing the pixel electrode by removing the portion of the first insulating layer exposed by the opening of the second insulating layer.

11. The method of claim 10, wherein the opening formed in the second insulating layer exposes only a portion of the first insulating layer corresponding to only a central portion of the pixel electrode, and
in the exposing the pixel electrode, only the central portion of the pixel electrode is exposed.

12. The method of claim 10, wherein the second insulating layer is comprised of a black matrix forming material.

13. The method of claim 10, wherein the first insulating layer is comprised of an element selected from a group consisting of silicon oxide, silicon nitride, aluminum oxide, indium oxide, thoron oxide and polyimide.

14. A method of fabricating an organic light emitting display, comprising:
forming a conductive layer on a substrate;
forming a first insulating layer on the conductive layer;
forming a pixel electrode and a sacrificial layer which covers the pixel electrode and has ends corresponding to ends of the pixel electrode respectively by pattering the conductive layer and the first insulating layer into a closed pattern away from edges of the substrate;
forming a second insulating layer covering the pixel electrode and the sacrificial layer;
exposing the sacrificial layer by forming an opening in the second insulating layer; and
exposing the pixel electrode by removing the sacrificial layer.

15. The method of claim 14, wherein the second insulating layer is comprised of a black matrix forming material.

16. The method of claim 14, wherein the first insulating layer is comprised of an element selected from a group consisting of silicon oxide, silicon nitride, aluminum oxide, indium oxide, thoron oxide and polyimide.
